(19) United States
(12) Patent Application Publication
(10) Pub. No.: US 2010/0188692 A1
(43) Pub. Date: Jul. 29, 2010

(54) Printing System, Printing Apparatus, and Printing Method

(75) Inventor: Yoshiyuki BABA, Shiojiri-shi (JP)

Correspondence Address: Hogan Lovells US LLP, 1999 AVENUE OF THE STARS, SUITE 1400, LOS ANGELES, CA, 90067, US

(73) Assignee: Seiko Epson Corporation, Tokyo (JP)

(21) Appl. No.: 12/634,191

(22) Filed: Dec. 9, 2009

(30) Foreign Application Priority Data
Jan. 27, 2009 (JP) 2009-015818

(51) Int. Cl. G06F 15/00

(52) U.S. Cl. 358/1.15

(57) ABSTRACT

Provided is a printing system for printing print data described in a page description language by using a printing apparatus, and the system includes a storage that stores an interpreter that interprets the page description language. In the system, the printing apparatus includes an interpreter acquisition unit that acquires an interpreter necessary for interpreting the print data described in the page description language from the storage before executing the printing of the print data, a language interpretation unit that interprets the print data by using the interpreter acquired by the interpreter acquisition unit, and a printing control unit that executes printing based on the print data interpreted by the language interpretation unit, and the storage is connected so as to be accessible from the printing apparatus.

### BACKGROUND

1. Technical Field

The present invention relates to a printing process for print data described in a page description language.

2. Related Art

In recent years, printers have tended to be equipped with multiple functions. Accompanying the multiple functions of printers, the capacity of a ROM included in a printer is increasing, because the ROM stores programs, for example, a plurality of interpreters for interpreting print data described in a page description language, in order to realize those functions. Some of the programs are stored in a compressed format in a ROM in the main body of a printer. As the volume of the programs increases, the capacity of the ROM is apt to be insufficient. Therefore, programs stored in the main body of a printer are required to have reduced volume. Techniques are disclosed in, for example, JP-A-7-334318 and JP-A-2000-222145 for prompting an external device connected to a printer to store those programs and execute operating processes.

According to the related art, there is disclosed a technique in which a program and a functioning part necessary for processing print data are provided in both the external device and the printer, and it is determined which one out of the external device and the printer is more efficient in executing the processing of the print data before executing the printing, and the process is executed by the one with higher efficiency. Accordingly, it is impossible to reduce the capacity of a memory storing programs in the main body of the printer.

### SUMMARY

An advantage of some aspects of the invention is that it provides a technique for reducing the capacity of a storage device used to store programs in the main body of a printer.

The invention may employ the following example or applications in order to solve at least part of the above-described problem.

### Application 1

According to a first aspect of the invention, there is provided a printing system for printing print data described in a page description language by using a printing apparatus. The system includes storage that stores an interpreter that interprets the page description language, and the printing apparatus includes an interpreter acquisition unit that acquires an interpreter necessary for interpreting the print data described in the page description language from the storage before executing the printing of the print data, a language interpretation unit that interprets the print data by using the interpreter acquired by the interpreter acquisition unit, and a printing control unit that executes printing based on the print data interpreted by the language interpretation unit. In the printing system, the storage is connected so as to be accessible from the printing apparatus.

In the printing system according to the above aspect, the printing apparatus acquires the interpreter that interprets the page description language from the storage before executing printing. There is no need for the printing apparatus to always store the interpreter therein. The apparatus may store one or a few interpreters as defaults.

### Application 2

According to the above aspect, there is provided a printing system where the interpreter acquisition unit analyzes the print data described in the page description language and determines an interpreter that is necessary for interpreting the page description language.

In the printing system according to the above aspect, the printing apparatus determines the interpreter necessary for interpreting the page description language of the print data before executing printing. Accordingly, there is no need for a user to input information on the interpreter to the printing apparatus.

### Application 3

According to the above aspect, there is provided a printing system where the storage further stores a plurality of interpreters that is used for interpreting a page description language of print data.

In the printing system according to the above aspect, the storage stores a plurality of interpreters used for interpreting a page description language of print data and a printing apparatus can acquire such interpreters. The printing apparatus can execute printing process in response to print data described in various page description languages. Furthermore, the storage may store a plurality of different kinds of interpreters, different versions of the same kind of interpreters. Furthermore, different storages may store different kinds of interpreters, respectively.

### Application 4

According to the above aspect, there is provided a printing system where the storage is provided in a computer connected to the printing apparatus so as to exchange data, and the computer is provided with an interpreter transmission controlling unit that selects an interpreter requested by the interpreter acquisition unit from among the plurality, of interpreters stored in the storage and transmits the selected interpreter to the printing apparatus.

In the printing system according to the above aspect, the computer selects an interpreter requested by a printing apparatus and transmits it to the printing apparatus. Accordingly, there is no need for a user to operate the computer so as to transmit the interpreter.

### Application 5

According to a second aspect of the invention, there is provided a printing apparatus for printing print data described in a page description language, and the apparatus includes an interpreter acquisition unit that acquires an interpreter necessary for interpreting the print data described in the page description language from outside before executing the printing of the print data.

In the printing apparatus according to the above aspect, an interpreter necessary for interpreting print data described in a page description language can be acquired from outside. Accordingly, there is no need to always store the interpreter in the printing apparatus.

### Application 6

According to a third aspect of the invention, there is provided a printing method of printing print data described in a page description language. The method includes determining an interpreter necessary for interpreting the print data described in a page description language by analyzing the print data before executing the printing of the print data, acquiring the determined interpreter from storage connected so as to be accessible, interpreting the print data described in the page description language by using the acquired interpreter, and executing printing based on the interpreted print data.

In the printing method according to the above aspect, there is no need to prepare in advance an interpreter necessary for printing print data.

The invention can be realized in various embodiments. The examples include a printing method and apparatus, a printing system, an integrated circuit for realizing such a method and apparatus, a computer program, and a recording medium recording such a computer program.

### BRIEF DESCRIPTION OF THE DRAWINGS

The invention will be described with reference to the accompanying drawings, wherein like numbers reference like elements.

FIG. 1 is a diagram schematically illustrating the configuration of a printing system according to a first example.

FIG. 2 is a diagram illustrating the configuration of a server according to the first example.

FIG. 3 is a diagram illustrating the configuration of a printer according to the first example.

FIG. 4 is a flowchart illustrating the flow of information in a printing process executed by the printing system.

FIG. 5 is a flowchart illustrating a printing process executed by the printer.

FIG. 6 is a diagram illustrating an example of header information of print data.

FIG. 7 is a flowchart illustrating an interpreter transmitting process executed by the server.

### DESCRIPTION OF EXEMPLARY EMBODIMENTS

Hereinafter, exemplary embodiments of the invention will be explained in detail based on examples (in the order below).
A. First Example
(A1) The schematic configuration of the printing system
(A2) The configuration of the server
(A3) The configuration of the printer
(A4) The operation of the printing system
B. Modified Example

### A. First Example

### (A1) The Schematic Configuration of the Printing System

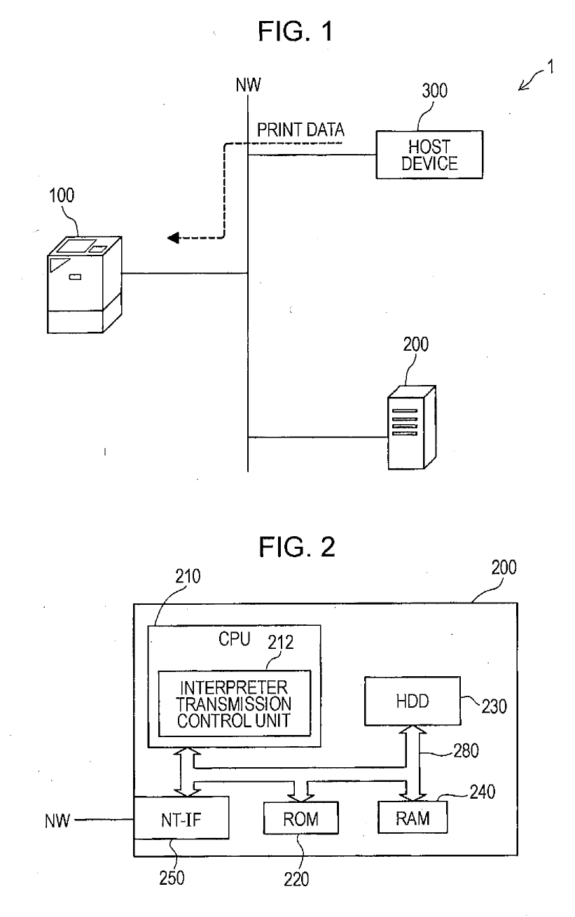

FIG. 1 is a diagram schematically illustrating the configuration of the printing system 1 according to a first example. The printing system 1 according to the first example is provided with a printer 100, a server 200 and a host device 300. The printer 100, the server 200 and the host device 300 are connected one another via a local area network (LAN). The LAN may be connected to other devices such as a client computer, a scanner, a projector and the like that are accessible through the network. In addition, the present example uses a wired LAN as the network as shown in FIG. 1, but a wireless LAN may be used.

The host device 300 transmits print data to the printer 100 via the network. The printer 100 receives the print data described in a page description language from the host device 300 and executes a printing process based on the print data. The server 200 will be described in detail below.

### (A2) The Configuration of the Server

As described above, the printer 100 according to the present example executes printing by interpreting print data described in the page description language. A program called an interpreter is necessary for interpreting the print data described in the page description language. In the present example, the server 200 stores and manages the interpreter for various page description languages. Next, the configuration of the server 200 will be described.

FIG. 2 is a diagram illustrating the configuration of the server 200 according to the first example. The server 200 is provided with a known CPU 210, a ROM 220, hard disk (HDD) 230, a RAM 240, and a network interface (hereinafter, referred to as “NT-IF”) 250, and all the components are connected to one another via a bus 280.

The ROM 220 stores a BIOS program necessary for starting the server 200. When the server 200 starts, the CPU 210 accesses the ROM 220 so as to execute the BIOS. As the BIOS is executed, an operating system (hereinafter, referred to as “server OS”) stored in a predetermined track of the HDD 230 is loaded on the RAM 240, and then control is transferred to the server OS. The CPU 210 includes an interpreter transmission, controlling unit 212. This interpreter transmission controlling unit 212 is realized by the execution of a program stored in the HDD 230.

The HDD 230 is a storing device that stores data using magnetism and stores the above-described server OS and other application programs. The RAM 240 constitutes the main memory in the CPU 210. The CPU 210 loads necessary programs in the main memory in order to execute them.

The server 200 in the present example may be an Internet server accessible via the Internet, or an intranet server accessible only within a LAN.

### (A3) The Configuration of the Printer

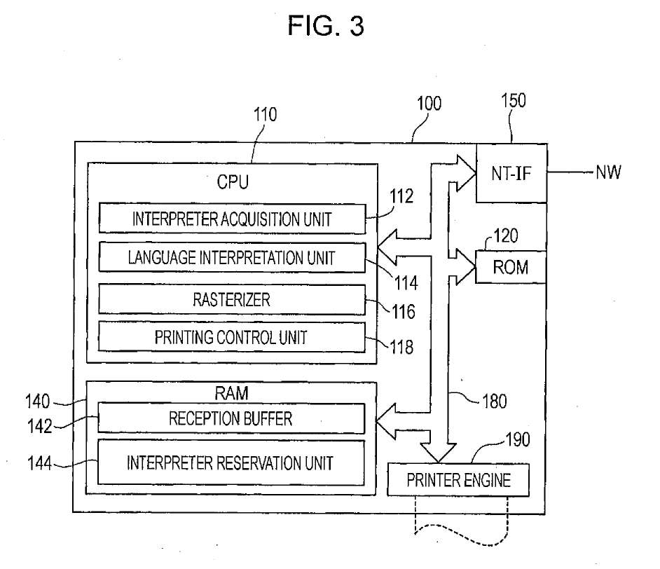

The configuration of the printer 100, that downloads a necessary interpreter from the above-described server 200 to execute printing, will be described below. FIG. 3 is a diagram illustrating the configuration of the printer 100 according to the first example. The printer 100 is provided with a known CPU 110, a ROM 120, a RAM 140, a NT-IF 150, and a printer engine 190, and all the components are connected to one another via a bus 180.

The ROM 120 stores an operating system (hereinafter, referred to as “OS”) for controlling all of the operations of the printer 100; a network control program, a font program, and the like. Furthermore, the ROM 120 does not store an interpreter that is provided in a printer of which there generally is at least one. The interpreter is a program that converts print data, which are described in a page description language, that a printer receives from a host device or a storing medium into a program language interpretable by the printer.

The CPU 110 is provided with an interpreter acquisition unit 112, a language interpretation unit 114, a rasterizer 116, and a printing control unit 118. The operation of each of the units included in the CPU 110 is realized by the execution of a program stored in the ROM 120. Functions of those units will be described in detail below.

The RAM 140 is provided with a reception buffer 142 and an interpreter reservation unit 144. The reception buffer 142 temporarily stores print data received from the host device 300. The interpreter reservation unit 144 will be explained later. The printer engine 190 is a printing mechanism for forming an image by transferring and fixing toner on a print sheet by using a photoconductive drum. The printer engine 190 executes printing by the control of the printing control unit 118.

### (A4) The Operation of the Printing System

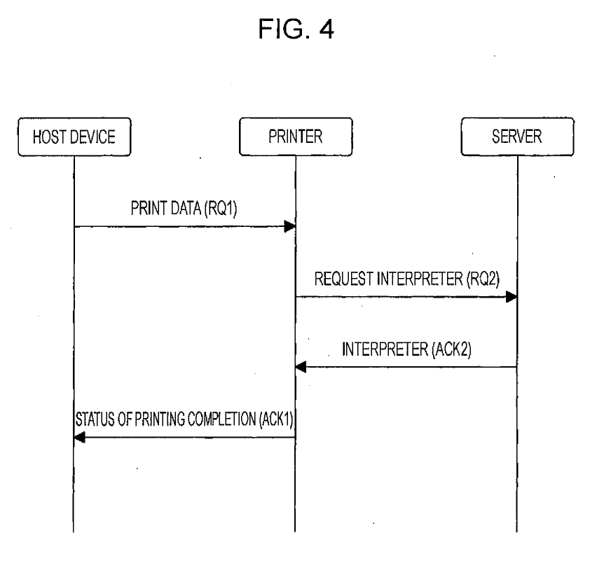

FIG. 4 is a flowchart illustrating the flow of information in a process executed by the printing system 1. The host device 300 transmits print data described in a page description language to the printer 100 via the network (RQ1 in FIG. 4). The printer 100 receives the print data and stores the data in the reception buffer 142. Then, the printer 100 requests an interpreter necessary for interpreting the print data to the server 200 (RQ 2).

The server 200 receives the request for an interpreter (RQ 2) from the printer 100, and transmits an interpreter requested by the printer 100 from among a plurality of interpreters included in the server 200 to the printer 100 (ACK 2). The printer 100 receives the interpreter from the server 200, interprets the print data stored in the reception buffer 142 by using the interpreter, and converts the data into a program language interpretable by the printer. The printer 100 executes printing based on the converted program language.

The printer 100 transmits the status of printing completion to the host device 300 after ending the printing (ACK 1). The host device 300 that received the status of printing completion displays a message that is notification of the completion of the printing on a display (not shown in the drawing) included in the host device 300 so as to inform a user of the host device 300 of the printing completion, and the printing process by the printing system 1 ends.

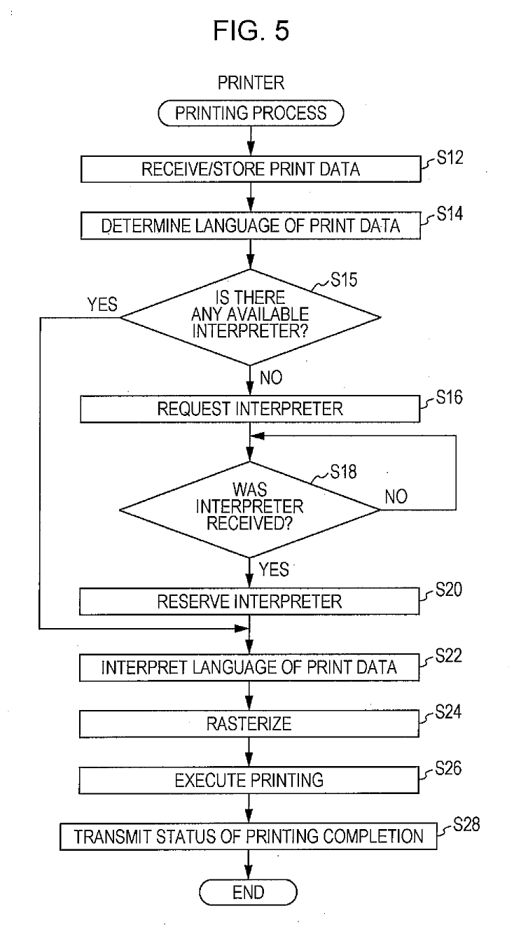

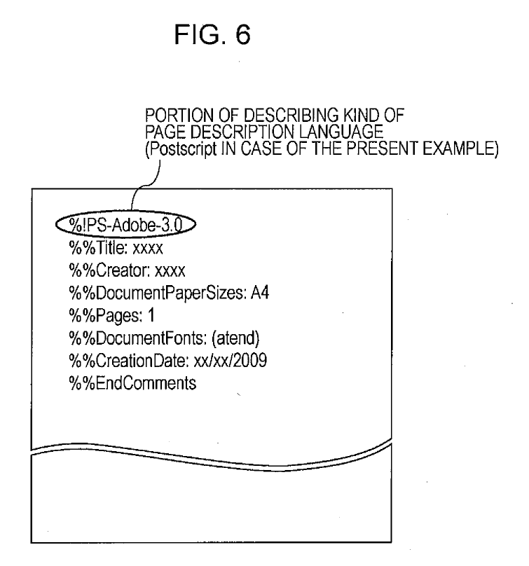

The process executed by the printer 100 in the above-described printing process will be described in detail. FIG. 5 is a flowchart illustrating a printing process executed by the printer 100. When the print data is received from the host device 300 (RQ1 in FIG. 4), the CPU 110 of the printer 100 (in FIG. 3) stores the print data in the reception buffer 142 (Step S12 in FIG. 5). After storing the print data, the CPU 110 reads the print data described in a page description language from the reception buffer 142 and analyzes it, and determines the kind of the page description language of the print data based on the header information of the print data (Step S14). The process is executed by the CPU 110 as a function corresponding to that of the interpreter acquisition unit 112. The example of the header information of the print data is shown in FIG. 6. “Adobe” and “PostScript” shown in FIG. 6 are registered trademarks.

When the determination on the kind of the page description language of the print data ends, the CPU 110 accesses the interpreter reservation unit 144 and finds out whether the interpreter for interpreting the page description language has already been acquired in the previous printing process based on the determination result (Step S15). In case where printing is performed for the first time after the supply of electric power to the printer, an interpreter is not stored in the interpreter reservation unit 144. Thus, the printer transmits a command (RQ 2) for requesting an interpreter to the server 200 (Step S16). As described above, the server 200 transmits an interpreter that the printer 100 needs according to the request of the interpreter (RQ 2) from the printer 100 (ACK 2). When the printer 100 receives the interpreter (ACK 2, Step S18), the CPU 110 stores the interpreter in the interpreter reservation unit 144 included in the RAM 140 (Step S20).

As a function corresponding to that of the language interpretation unit 114, the CPU 110 reads and interprets the print data described in the page description language from the reception buffer 142 by using the interpreter stored in the interpreter reservation unit 144, and converts the data into an intermediate language that can be processed by the rasterizer 116 which will be described later (Step 522).

As a function corresponding to that of the rasterizer 116, the CPU 110 rasterizes the print data converted into the intermediate language by the language interpretation unit 114, and converts the data into bitmap data (Step S24). As a function corresponding to that of the printing control unit 118, the CPU 110 executes printing by controlling the printer engine 190 (in FIG. 3) based on the bitmap data (Step S26). After the completion of the printing, the status of the printing completion is transmitted to the host device 300 (Step S28) and the printer 100 ends the printing process. In addition, in Step S15, the interpreter used in the printing process is stored in the interpreter reservation unit 144 until the power of the printer 100 is switched off. When new print data is received from the host device 300 and it is determined that the print data can be interpreted with the interpreter stored in the interpreter reservation unit 144, the interpreter is again used in printing process. In other words, Step S15 jumps to Step S22. Therefore, the printer does not again request an interpreter to the server 200.

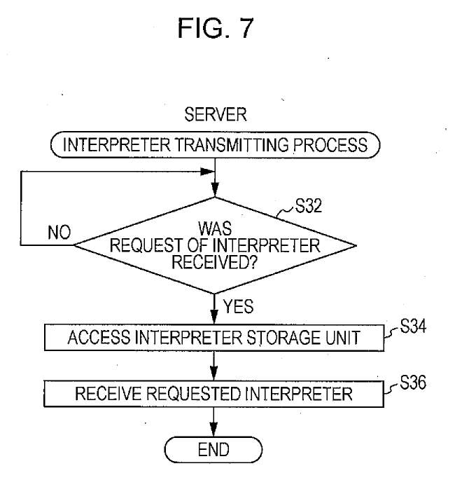

Next, a transmitting process of the interpreter executed by the server 200 in the above-described printing process by the printing system 1 will be explained. FIG. 7 shows the interpreter transmitting process executed by the server 200. When the request of an interpreter (RQ2 in FIG. 4) is received from the printer 100 (Step S32), as a function corresponding to that of the interpreter transmission controlling unit 212, the CPU 210 (see FIG. 2) accesses the HDD 230 (Step S34). The HDD 230 stores a plurality of interpreters so as to respond to various page description languages. The stored interpreters can interpret print data described in page description languages such as PostScript (registered trademark), ESC/Page (registered trademark), LIPS (registered trademark), HP-PCL (registered trademark), and the like. The CPU 210 selects an interpreter requested by the printer 100 from among the plurality of interpreters stored in the HDD 230, and transmits the interpreter to the printer 100 via the network (Step S36). After the transmission of the interpreter, the interpreter transmitting process by the server 200 ends.

According to the printing system 1 in the first example as described above, the printer 100 acquires an interpreter from the server 200 when the printer 100 is about to execute a printing process based on print data. For this reason, there is no need for the printer to always store an interpreter in the ROM 120. Therefore, it is possible to reduce the volume of programs stored in the ROM 120. Furthermore, when the server 200 is a server of a company which is connected to the intranet, an administrator of the server can consolidate the management of the interpreters used in the company. Therefore, when updating the version of the interpreter, only the interpreter stored in the server needs to be updated, which makes it possible to avoid the inconvenience of updating the interpreter for each of the printers. Moreover, when the server 200 is an Internet server, there is no need to update the version of the interpreter, and the latest interpreter can always be acquired by the access to the server 200 by the printer 100. Therefore, it is possible to execute a printing process in response to various page description languages when the printer 100 prints print data.

### B. Modified Example

The invention is not limited to the above example or embodiment, but can be modified in various embodiments without departing from the spirit of the invention. For example, the following modified examples are possible.

### B1. Modified Example 1

The server 200 in the first example executes the interpreter transmitting process, but the functions of the server 200 may be provided in a host device. In this case, the host device transmits both the print data and the interpreter. Therefore, the host device may determine in advance an interpreter necessary for interpreting the print data based on the transmitted print data and transmit the interpreter to the printer. In other words, the process of determining the language of the print data performed by the printer in the first example can be performed by the host device in the modified example 1. Accordingly, the process of determining the language of the print data by the printer can be omitted, and the process burden on the printer can be lowered. Therefore, the speed of the printing process can be enhanced. Moreover, since the modified example 1 does not need a server, the printer and the host device do not need to be connected to the Internet or intranet, but may be connected by cables to each other via a connection interface such as USB, 1E5E1394, or the like.

### B2. Modified Example 2

In addition to the embodiment in the above-described modified example 1, the print data transmitted by the host device may be print data typically only described in one kind of page description language. In this case, the printer and the host device do not need to perform the process of determining the language of the print data, and thereby the speed of the printing process can be enhanced further compared to that in the modified example 1.

### B3. Modified Example 3

In the first example, the printer 100 receives the print data from the host device 300. However, the printer may be provided with a recording medium reading unit that can read a recording medium in which the print data are recorded to acquire the print data from the recording medium, and to execute a printing process by using the interpreter acquired from the server.

### B4. Modified Example 4

The server 200 may store the plurality of different kinds of interpreters, or store different versions of the same kind of interpreter. Furthermore, the server 200 does not need to include all kinds of interpreters, but the plurality of interpreters may be dispersed in a plurality of servers accessibly connected to the printer 100.

### B5. Modified Example 5

In the above-described examples, part of the functions realized by software can be realized by hardware, or part of the functions realized by hardware can be realized by software.

The entire disclosure of Japanese Patent Application No. 2009-015818, filed Jan. 27, 2009 is expressly incorporated by reference herein.

What is claimed is:

1. A printing system for printing print data described in a page description language by a printing apparatus, the system comprising:
a storage that stores an interpreter that interprets the page description language,
wherein the printing apparatus includes an interpreter acquisition unit that acquires an interpreter necessary for interpreting the print data described in the page description language from the storage before executing the printing of the print data, a language interpretation unit that interprets the print data by using the interpreter acquired by the interpreter acquisition unit, and a printing control unit that executes printing based on the print data interpreted by the language interpretation unit, and
wherein the storage is connected so as to be accessible from the printing apparatus.

2. The printing system according to claim 1, wherein the interpreter acquisition unit analyzes the print data described in the page description language and determines an interpreter that is necessary for interpreting the page description language.

3. The printing system according to claim 1, wherein the storage further stores a plurality of interpreters that is used for interpreting a page description language of print data.

4. The printing system according to claim 3,
wherein the storage is provided in a computer connected to the printing apparatus so as to exchange data, and
the computer is provided with an interpreter transmission controlling unit that selects an interpreter requested by the interpreter acquisition unit from among the plurality of interpreters stored in the storage and transmits the selected interpreter to the printing apparatus.

5. A printing apparatus for printing print data described in a page description language, the apparatus comprising an interpreter acquisition unit that acquires an interpreter necessary for interpreting the print data described in the page description language from outside before executing the printing of the print data.

6. A printing method of printing print data described in a page description language, comprising:
determining an interpreter necessary for interpreting the print data described in a page description language by analyzing the print data before executing the printing of the print data,
acquiring the determined interpreter from a storage connected so as to be accessible,
interpreting the print data described in the page description language by using the acquired interpreter, and
executing printing based on the interpreted print data.
